(19) United States
(12) Patent Application Publication
(10) Pub. No.: US 2002/0140559 A1
(43) Pub. Date: Oct. 3, 2002

(54) System and method for remotely monitoring

(76) Inventors: Peter Y. Zhou, Smithtown, NY (US); Dexing Pang, Smithtown, NY (US)

Correspondence Address: KENYON & KENYON, ONE BROADWAY, NEW YORK, NY, 10004, US

(21) Appl. No.: 09/820,551

(22) Filed: Mar. 29, 2001

(51) Int. Cl. G08B 1/00; H04Q 1/30; G08B 23/00; G08G 1/123

(52) U.S. Cl. 340/573.1; 340/573.4; 340/988; 340/531

(57) ABSTRACT

A method and a system for remotely monitoring a person include a portable unit, a global positioning system (GPS) satellite, a central unit and a ground station. The portable unit is adapted to monitor a biological parameter and a physical location of the person and is adapted to be a part of an artificial body part of the person. Furthermore, the portable unit is disposed proximately to a skin surface of the person. The GPS satellite transmits GPS data to the portable unit. The central unit, which is disposed remotely from the portable unit, is in communication with the portable unit via the ground station.

### FIELD OF THE INVENTION

The present invention generally relates to a system and a method for remotely monitoring, and, more specifically, to a system and a method for remotely monitoring a person.

### BACKGROUND INFORMATION

Medical devices that monitor a biological parameter of a patient are often installed using an invasive procedure such as surgery. Such devices have a disadvantage in that invasive procedures are costly, labor intensive and inherently risky.

Furthermore, medical devices that require surgery are typically disposed deep within the body limiting greatly the possibility of remotely monitoring the patient. Deep implants have a disadvantage in that they are not within the penetration range of high frequency signals due to high frequency scattering effects of the body. High frequency signals are commonly used for determining a physical location in a global positioning system (GPS). Accordingly, without access to high frequency signals, a deeply implanted medical device cannot use the GPS for determining the physical location of the patient being monitored.

What is needed to help avoid these disadvantages is a non-invasive portable monitoring device which wirelessly transmits information relating to a biological parameter and a physical location of a person that is being monitored to a central unit in a hospital, for example.

### SUMMARY OF THE INVENTION

The present invention provides for a system for remotely monitoring a person including a portable unit adapted to monitor a biological parameter and a physical location of the person, the portable unit being adapted to be a part of an artificial body part of the person; a global positioning satellite transmitting global positioning system (GPS) data to the portable unit; and a central unit disposed remotely from the portable unit, the central unit being in communication with the portable unit via a ground station.

The present invention also provides for a system for remotely monitoring a person including a portable unit adapted to monitor a biological parameter and a physical location of the person, the portable unit being adapted to be a part of an eyeglass worn by the person; a global positioning satellite transmitting global positioning system (GPS) data to the portable unit; and a central unit disposed remotely from the portable unit, the central unit being in communication with the portable unit via a ground station.

The present invention also provides for a portable unit for remotely monitoring a person including a microchip adapted to receive information relating to a physical location of the person and adapted to send information relating to the physical location and a biological parameter of the person, the microchip being adapted to be a part of an artificial body part of the person, the microchip being disposed proximately to a skin surface of the person; a receiver coupled to the microchip, the receiver being adapted to receive global positioning system (GPS) data; a transceiver coupled to the microchip, the transceiver being adapted to receive an interrogation signal and to transmit wireless information relating to the physical location and the biological parameter of the person; and a sensor coupled to the microchip, the sensor being adapted to send signals relating to a sensed biological parameter.

The present invention also provides for a method for remotely monitoring a person including the steps of adapting a portable unit as a part of an artificial body part of the person; receiving, by the portable unit, information relating to a physical location and a biological parameter of the person; and wirelessly communicating the information relating to the physical location and the biological parameter of the person from the portable unit to a central unit via a ground station.

### BRIEF DESCRIPTION OF THE DRAWINGS

FIG. 1 illustrates an embodiment of a system and a method for remotely monitoring of a person according to the present invention.

FIG. 2 illustrates an embodiment of a portable unit according to the present invention.

FIG. 3 illustrates exemplary locations for positioning the portable unit on a person according to the present invention.

### DETAILED DESCRIPTION

Although the present invention is generally applicable to systems and methods for remote monitoring, the following embodiments according to the present invention contemplate systems and methods for remotely monitoring a person.

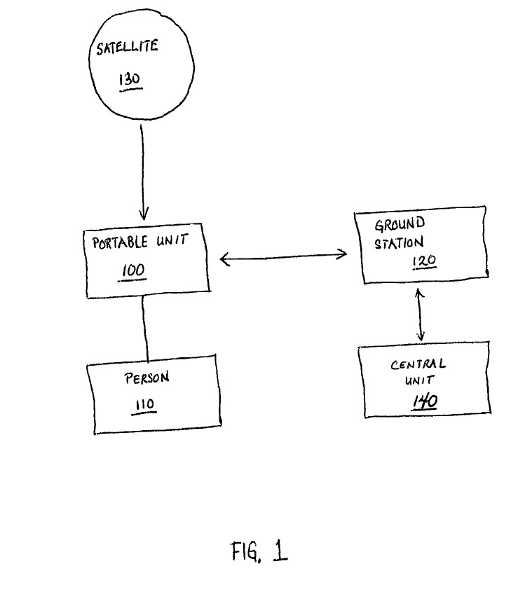

FIG. 1 illustrates an embodiment of a system and a method for remotely monitoring a person according to the present invention. A portable unit 100 is coupled to a person 110 that is to be monitored. The portable unit 100 is coupled to a satellite 130. The satellite 130 may be, for example, a set or an array of satellites of an existing global positioning system (GPS). The portable unit 100 is coupled to a ground station 120. The ground station 120 may be, for example, a part of an existing mobile phone grid or a radio communications array. The ground station 120 is coupled to a central unit 140.

The portable unit 100 is adapted to monitor biological parameters of the person 100. The portable unit may monitor acoustic, thermal, mechanical, chemical, electrical and/or electromagnetic parameters, for example, related to human biological parameters including, for example, temperature, heart rate, blood flow rate, muscular activity, respiratory rate, and/or brain activity of the person being monitored.

Furthermore, the portable unit 100 is adapted to monitor the physical location of the person 110. In an embodiment according to the present invention, the portable unit 100 receives GPS data transmitted by the satellite 130. With the GPS data, information relating to a physical location of the person 110 may be determined.

In an embodiment according to the present invention, the central unit 140 makes a request for information to the ground station 120, with which the central unit 140 is in two-way communication. The ground station 120 wirelessly transmits an interrogation signal to the portable unit 100, with which the ground station 120 is in two-way wireless communication. In response to the interrogation signal, the portable unit 100 wirelessly transmits information relating to the physical location and/or the human biological parameters of the person 110 being monitored. Further information can be sent that is stored in the portable unit 100 such as, for example, identifying information, personal information or special medical information such as personal medical conditions. The ground station 120 sends information relating to information received from the portable unit 100 to the central unit 140. The information received by the central unit 140 can ultimately be stored, displayed, printed, processed or sent to other central units in a network, for example.

The central unit 140, which may be located in a hospital or a monitoring center, for example, may make the request for information periodically or aperiodically, for example, by manual intervention or a command triggered by a particular circumstance. Furthermore, the central unit 140 may be in wire-to-wire or wireless communication with the ground station 120.

In another embodiment according to the present invention, the portable unit 100, without the receipt of the interrogation signal from the ground station 120, periodically sends information to the ground station 120. Information relating to the received information is sent by the ground station 120 to the central unit 140. In yet another embodiment according to the present invention, the portable unit 100 sends information to the ground station 120 in response to a particular circumstance monitored by the portable unit 100 or in response to a manual command by the person 110 being monitored. For example, the portable unit 100 may send information to the ground station 120 in response to a particular biological parameter which may be indicative of a dangerous medical condition. In another example, the portable unit 100 sends information to the ground station 120 in response to a manual actuation of a switch or a specifically programmed button by the person 100.

The processing of data relating to, for example, the physical location and/or the human biological parameters of the person 110 being monitored may occur either in the portable unit 100, the ground station 120, the central unit 140 or some combination thereof. For example, the portable unit 100 may receive GPS data from the satellite. The GPS data is processed by the portable unit 100, the portable unit 100 calculating the physical location of the person 110 before sending the calculated physical location to the ground station 120 and, subsequently, to the central unit 140. Alternatively, the GPS data received by the portable unit 100 may be sent to the ground station 120, which processes the information and calculates the physical location of the person 110, the calculated physical location of the person being sent to the central unit. In yet another alternative, the GPS data is sent to the portable unit 100 which sends the information to the ground station 120 which, in turn, sends the information to the central unit 140. In this embodiment, it is the central unit 140 which processes the GPS data and calculates the physical location of the person 110. Furthermore, the present invention contemplates a distributed processing scheme in which part of the processing of the information received by the portable unit 100 from the person 110 and/or the satellite 130 is processed, in part, by a combination of the portable unit 100, the ground station 120 and/or the central unit 140.

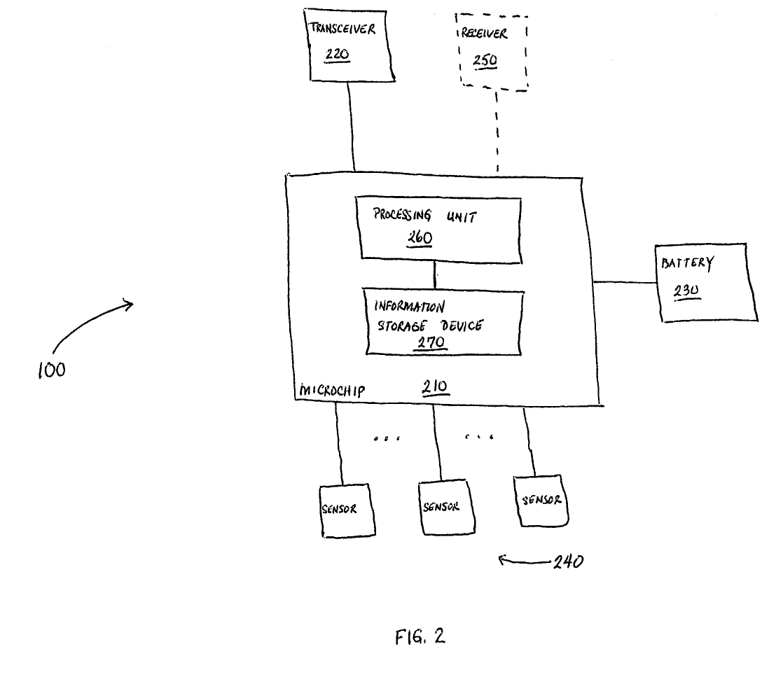

FIG. 2 illustrates an embodiment of a portable unit 100 according to the present invention. The portable unit 100 includes a microchip 210, a transceiver 220, a battery 230 and at least one sensor 240. The portable unit 100 may optionally include a receiver 250. Furthermore, the microchip 210 includes a processing unit 260 and an information storage device 270.

Although FIG. 2 illustrates some parts included on the microchip 210 and some parts coupled to the microchip 210, one of ordinary skill in the art understands, and the present invention contemplates, that different levels of integration may be achieved by integrating any of the coupled parts as illustrated in FIG. 2 onto the microchip 210.

The battery 230, the at least one sensor 240, the transceiver 220 and, optionally, the receiver 250 are each coupled to the microchip 210. In an embodiment according to the present invention, the at least one sensor 240, the transceiver 220 and, optionally, the receiver 250 are each coupled to the processing unit 260, which, in turn, is coupled to the information storage device. The battery 230 powers the microchip 210, including the processing unit 260 and the information storage device 270. The battery 230 may also power directly or indirectly the transceiver 220, the at least one sensor 240 and/or, optionally, the receiver 250. The battery 230 may be a rechargeable or a single-charge power supply device.

In an embodiment according to the present invention, the battery 230 is recharged by energy sources internal to a body of the person 110 being monitored. Such energy sources may be, for example, acoustic, mechanical, chemical, electrical, electromagnetic or thermal in nature as derived from, for example, bodily temperature differences, muscle activity and vibrations due to pulse, speaking, breathing, etc.

In another embodiment according to the present invention, the battery 230 is recharged by energy sources external to the body of the person 110 being monitored. Such energy sources may be, for example, acoustic, mechanical, chemical, electrical, electromagnetic or thermal in nature as derived from, for example, temperature differences between the ambient and the body, vibrations due to ambient noise, ambient light, or an external device providing energy for the rechargeable battery 230.

In an embodiment according to the present invention, the transceiver 220 is adapted to be in two-way wireless communication with the ground station 120 and in one-way wireless communication with the satellite 130. The transceiver 220 may be a single antenna or an antenna array, for example.

In another embodiment according to the present invention, the portable unit 100 includes the transceiver 220 and the receiver 250. In this embodiment, the transceiver 220 is in two-way wireless communication with the ground station 120 and the receiver 250 is in one-way wireless communication with the satellite 130. The use of the transceiver 220 and the receiver 250 is advantageous in that the portable unit 100 generally consumes less energy. GPS frequencies tend to be relatively high and sending information over such frequencies by the portable unit 100 via the transceiver 220 can be energy intensive. This embodiment contemplates the receiver 250 being adapted for receiving at high frequencies and the transceiver 220 being adapted for receiving and sending at lower frequencies. The sending of information over lower frequencies by the transceiver 220 results in less energy consumption by the portable unit 100.

The at least one sensor 240 is adapted to monitor acoustic, thermal, mechanical, chemical, electrical and/or electromagnetic parameters, for example, related to human biological parameters including, for example, temperature, heart rate, blood flow rate, muscular activity, respiratory rate, and brain activity of the person being monitored. The conversion of acoustic, thermal, mechanical, chemical, electrical and/or electromagnetic parameters into electrical signals, for example, is understood by one of ordinary skill in the art and is not detailed further.

The microchip 210 includes the processing unit 260 and the information storage device 270 in an embodiment according to the present invention. The processing unit 260 may include, for example, a microprocessor, a cache, input terminals and output terminals. The processing unit 260 may include an information storage device which includes an electronic memory which may or may not include the cache of the processing unit 260.

In operation, according to at least one embodiment of the present invention, the receiver 250 receives GPS data from the satellite 130. The GPS data is received by the microchip 210 and, in particular, the processing unit 260. Although the GPS data is continuously received by the receiver 250, the processing unit 260 may periodically (i.e., via a time-based trigger) or aperiodically (i.e., via manual intervention or as a function of circumstance, for example, the sensing of a particular biological condition) receive the GPS data. The GPS data may then be processed in the processing unit 260 which may include determining the physical location of the person 110 being monitored. The GPS data and/or the determined physical location are stored in the information storage device 270.

The at least one sensor 240 senses biological parameters of the person 110. These biological parameters are converted into electrical signals by the at least one sensor 240 and received by the processing unit 260. The sensing of biological parameters by the at least one sensor 240 may be a periodic (e.g., time based) or an aperiodic function (i.e., triggered by a request from the processing unit 260 or as a function of circumstance, for example, the sensing of a particular parameter). The processing unit 260 may process the electrical signals by converting them into information relating to, for example, a measure of temperature, heart rate, blood flow rate, muscular activity, respiratory rate, and/or brain activity. The processing unit 260 stores the processed and/or unprocessed electrical signals in the information storage device 270. The transceiver 220 receives the interrogation signal, for example, from the ground station 120. The transceiver 220 then sends the interrogation signal to the microchip 210, in particular, to the processing unit 260. Upon receiving the interrogation signal, the processing unit 260 uploads the information stored in the information storage device onto the transceiver 220. The transceiver then sends the uploaded information to the ground station 120.

In another embodiment according to the present invention, the microchip is activated only when the transceiver 220 receives the interrogation signal from the ground station 120. This embodiment has an advantage in that energy consumption is minimized. Upon receiving the interrogation signal, the processing unit 260 accepts data from the receiver 250 and the at least one sensor 240. The processing unit 260 may accept the data over a time interval to achieve more precise data or to develop a history of data. Such data may be processed and/or stored in the information storage device 270. Upon completion of the processing and/or storing of the data, the information contained in the information storage device is uploaded onto the transceiver 220 and transmitted to the ground station 120. After completing the transmission of the uploaded data via the transceiver 220, the processing unit 260 is no longer active in receiving, processing and/or storing information until the next interrogation signal is received from the ground station.

In another embodiment according to the present invention, the transceiver 220, without the optional receiver 250, is adapted to receive the GPS data from the satellite 130 and the interrogation signal from the ground station 120. Furthermore, the transceiver 220 transmits information from the processing unit 260 to the ground station. Operation is similar as described above.

The information storage device 270 may also store preset information relating to identification, personal information or special medical information, for example. This information may have been programmed before the coupling of the portable device 100 to the person 110. Alternatively, the information may have been transmitted to the portable device 100 after the portable device 100 was coupled to the person 110. Such information may include the person's name, home address, phone number and/or a listing of relatives to contact in case of emergency. Furthermore, the information permanently stored in the portable device 100 may relate to special medical information such as allergies to medication or that the patient is diabetic or asthmatic, for example. All of this information may be uploaded onto the transceiver 220 and transmitted to the ground station 120. Such information may be of special significance to medical personnel when the person is disoriented or unconscious and unable to communicate.

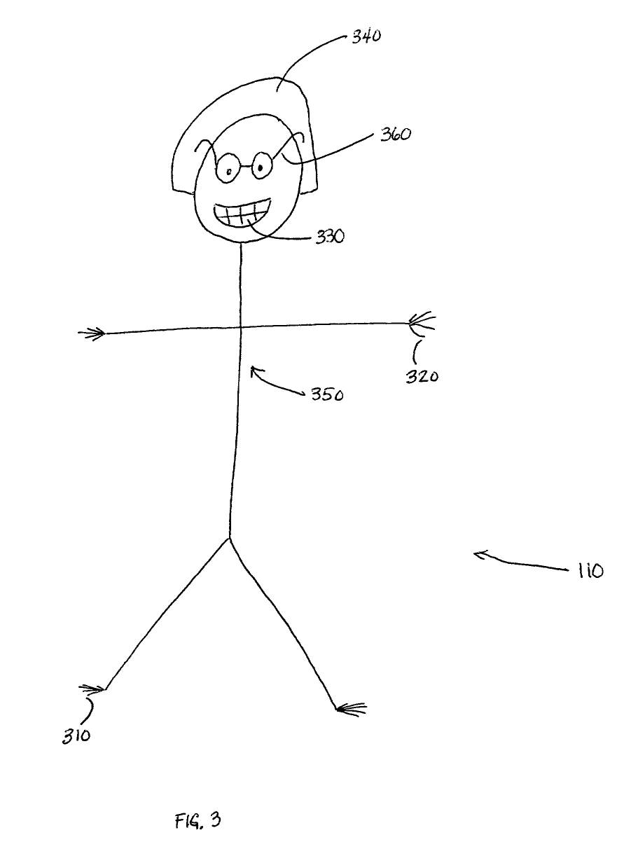

FIG. 3 illustrates exemplary locations for positioning the portable unit 100 on the person 110 according to the present invention. The present invention contemplates positioning the portable unit 100 in any number of non-invasive locations. These locations tend to be on or just under the surface of the body of the person 110. The portable unit 100 is advantageously placed on or just under the surface of the body to minimize interference in receiving signals, in particular, GPS data. GPS data tends to be sent on very high frequency signals which will not penetrate very far into the body of the person 110 without substantial scattering of the high frequency signals.

For example, in an embodiment according to the present invention, the portable unit 100 is placed in a false or artificial toe nail 310. The artificial toe nail 310 may replace a natural toe nail in part or in whole. For example, by cutting the natural toe nail in such a way that the portable unit 100 could be inserted, the portable unit 100 could monitor biological parameters of the person 110 via the toe. Alternatively, the natural toe nail could be thinned in certain areas upon which the portable unit 100 may be placed.

In another embodiment according to the present invention, the portable unit 100 is placed in a false or artificial finger nail 320. The portable unit 100 may be placed or inserted as described above with respect to the toe nail.

In still another embodiment according to the present invention, the portable unit 100 is part of a false or artificial tooth or set of teeth 330. The present invention contemplates, for example, filling a vacant tooth place in the mouth of the person 110 with the portable unit 100 adapted to be an artificial tooth. Alternatively, if the person 110 requires dentures, then the portable unit 100 may be adapted to part of the dentures.

In another embodiment according to the present invention, the portable unit 100 can be adapted to be part of an underside of a wig 340 which is removably attached to the head of the person 110. In this embodiment, the portable unit 100 is in contact with the head of the person 110.

In yet another embodiment according to the present invention, the portable unit 100 is adapted to be part of a breast or chest implant 350, the portable unit 100 being proximate to the outer surface of the implant 350 and being proximate to the skin surface of the body of the person 110.

In another embodiment according to the present invention, the portable unit 100 is adapted to be part of a frame of an eyeglass 360. In this embodiment, the at least one sensor 240 being in contact with the person 110 where the eyeglass 360 is in contact with the person 110.

In the foregoing description, the method and the system of the present invention have been described with reference to specific embodiments. It is to be understood and expected that variations in the principles of the method and the system herein disclosed may be made by one of ordinary skill in the art and it is intended that such modifications, changes and substitutions are to be included within the scope of the present invention as set forth in the appended claims. The specification and the drawings are accordingly to be regarded in an illustrative, rather than in a restrictive sense.

What is claimed is:

1. A system for remotely monitoring a person, comprising:
a portable unit adapted to monitor a biological parameter and a physical location of the person, the portable unit being adapted to be a part of an artificial body part of the person;
a global positioning satellite transmitting global positioning system (GPS) data to the portable unit; and
a central unit disposed remotely from the portable unit, the central unit being in communication with the portable unit via a ground station.

2. The system according to claim 1, wherein the artificial body part includes at least one of an artificial toe nail, an artificial finger nail, an artificial tooth, an artificial implant and an artificial hair piece.

3. The system according to claim 1, wherein the portable unit is disposed proximately to a skin surface of the person.

4. The system according to claim 1,
wherein the portable unit includes a microchip coupled to a transceiver, a battery and a sensor,
wherein the sensor is adapted to provide the microchip with signals relating to the biological parameter of the person,
wherein the transceiver is adapted to provide the microchip with the GPS data and is adapted to provide the microchip with an interrogation signal from the ground station, and
wherein, after the transceiver receives the interrogation signal, the microchip transmits information relating to the biological parameter and to the physical location of the person to the ground station via the transceiver.

5. The system according to claim 1,
wherein the portable unit includes a microchip coupled to a transceiver, a receiver, a battery and a sensor,
wherein the sensor is adapted to provide the microchip with a signal relating to the biological parameter of the person,
wherein the receiver is adapted to provide the microchip with the GPS data,
wherein the transceiver is adapted to provide the microchip with an interrogation signal from the ground station, and
wherein, after the microchip receives the interrogation signal, the microchip transmits information relating to the biological parameter and to the physical location of the person to the ground station via the transceiver.

6. The system according to claim 5, wherein the battery is rechargeable via an energy source occurring naturally within the person.

7. The system according to claim 5,
wherein the microchip includes a processing unit coupled to an information storage device,
wherein the processing unit is coupled to the receiver and is adapted to receive the GPS data from the receiver,
wherein the processing unit is coupled to the sensor and is adapted to receive the signal relating to the biological parameter of the person, and
wherein the processing unit is coupled to the transceiver and is adapted to receive the interrogation signal and to transmit information relating to the biological parameter and to the physical location of the person to the ground station via the transceiver.

8. The system according to claim 7, wherein, after receiving the interrogation signal, the processing unit receives the GPS data and the signal relating to the biological parameter of the person.

9. The system according to claim 8,
wherein the processing unit determines information relating to the physical location of the person as a function of the GPS data,
wherein the processing unit processes the signal relating to the biological parameter into information relating to the biological parameter, and
wherein the processing unit stores the information relating to the physical location and to the biological parameter in the information storage device.

10. The system according to claim 9, wherein, after receiving the interrogation signal, the processing unit sends information stored in the information storage device to the ground station via the transceiver.

11. The system according to claim 10, wherein the information stored in the information storage device includes preset information relating to at least one of identifying information, personal information and special medical information about the person.

12. A system for remotely monitoring a person, comprising:
a portable unit adapted to monitor a biological parameter and a physical location of the person, the portable unit being adapted to be a part of an eyeglass worn by the person;
a global positioning satellite transmitting global positioning system (GPS) data to the portable unit; and
a central unit disposed remotely from the portable unit, the central unit being in communication with the portable unit via a ground station.

13. A portable unit for remotely monitoring a person, comprising:
a microchip adapted to receive information relating to a physical location of the person and adapted to send information relating to the physical location and a biological parameter of the person, the microchip being adapted to be a part of an artificial body part of the person, the microchip being disposed proximately to a skin surface of the person;
a receiver coupled to the microchip, the receiver being adapted to receive global positioning system (GPS) data;
a transceiver coupled to the microchip, the transceiver being adapted to receive an interrogation signal and to transmit wireless information relating to the physical location and the biological parameter of the person; and
a sensor coupled to the microchip, the sensor being adapted to send signals relating to a sensed biological parameter.

14. A method for remotely monitoring a person, comprising the steps of:
adapting a portable unit as a part of an artificial body part of the person;
receiving, by the portable unit, information relating to a physical location and a biological parameter of the person; and
wirelessly communicating the information relating to the physical location and the biological parameter of the person from the portable unit to a central unit via a ground station.

15. The method according to claim 14, further comprising the step of:
receiving an interrogation signal from the ground station to the portable unit,
wherein the step of wirelessly communicating occurs after the step of receiving the interrogation signal.

16. The method according to claim 15, wherein the step of receiving the information relating to the physical location and the biological parameter of the person occurs after the step of receiving the interrogation signal.

17. The method according to claim 14, wherein the artificial body part includes at least one of an artificial toe nail, an artificial finger nail, an artificial tooth, an artificial implant and an artificial hair piece.

18. The method according to claim 14, further comprising the step of:
disposing proximately the portable unit to a surface of a skin of the person.

19. The method according to claim 14, wherein the step of receiving includes the step of receiving, from a global positioning system (GPS) satellite to the portable unit, information relating to the physical position of the person.
